(19) United States
(12) Patent Application Publication
(10) Pub. No.: US 2013/0156434 A1
(43) Pub. Date: Jun. 20, 2013

(54) REMOTE CONTROL SYSTEM AND APPARATUS

(71) Applicants: KUAN-HONG HSIEH, Tu-Cheng (TW); HAN-CHE WANG, Tu-Cheng (TW); HSIN-NAN HU, Tu-Cheng (TW); HAI-JIN LI, Shenzhen City (CN)

(72) Inventors: KUAN-HONG HSIEH, Tu-Cheng (TW); HAN-CHE WANG, Tu-Cheng (TW); HSIN-NAN HU, Tu-Cheng (TW); HAI-JIN LI, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/551,624

(22) Filed: Jul. 18, 2012

(30) Foreign Application Priority Data
Dec. 15, 2011 (CN) 201110420307.3

(51) Int. Cl. H04B 10/00

(52) U.S. Cl. 398/106

(57) ABSTRACT

A remote control system for remotely controlling a plurality of remote controllable appliances includes a mobile terminal and a remote control apparatus. The remote control apparatus includes a plurality of infrared transmitting modules corresponding to a remote controllable appliances. The mobile terminal generates a wireless signal carrying an identification including information of a selected appliance and a selected function. The remote control apparatus determines an infrared remote control code associated with the selected function, and generates an infrared remote control signal carrying the determined infrared remote control code to be transmitted to the selected appliance by the corresponding infrared transmitting module to execute the selected function.

### CROSS-REFERENCES TO RELATED APPLICATIONS

This application is related to a co-pending U.S. patent application, Attorney Docket Number US43689 and entitled “REMOTE CONTROL APPARATUS”, which has the same assignees as the current application.

### BACKGROUND

1. Technical Field

The present disclosure relates to remote controllers and, particularly, to a remote control system and an apparatus capable of remote control operation via a wireless mobile terminal.

2. Description of Related Art

Remote controls are generally employed to remotely control digital appliances within in a predetermined area. However, the remote controller can only be used to control a pre-designated appliance. Furthermore, the remote control can only control the digital appliance which is in the same room as the remote control. Therefore, if user has a number of appliances, a number of remote controls are needed. A number of remote controls are inconvenient for user.

### BRIEF DESCRIPTION OF THE DRAWINGS

The components of the drawings are not necessarily drawn to scale, the emphasis instead being placed upon clearly illustrating the principles of the disclosure. Moreover, in the drawings, like reference numerals designate corresponding parts throughout several views.

FIG. 1 is a schematic diagram of a remote control system in accordance with an exemplary embodiment.

FIG. 2 is a schematic diagram showing a state of use of selecting appliances on a mobile terminal of the remote control system of FIG. 1 in accordance with an exemplary embodiment.

FIG. 3 is a schematic diagram showing a state of use of providing a remote control interface of a selected appliance on the mobile terminal of the remote control system of FIG. 1 in accordance with an exemplary embodiment.

FIG. 4 is a block diagram of the remote control system of FIG. 1 in accordance with an exemplary embodiment.

FIG. 5 is a structure diagram of a remote control apparatus of the remote control system of FIG. 1 in accordance with an exemplary embodiment.

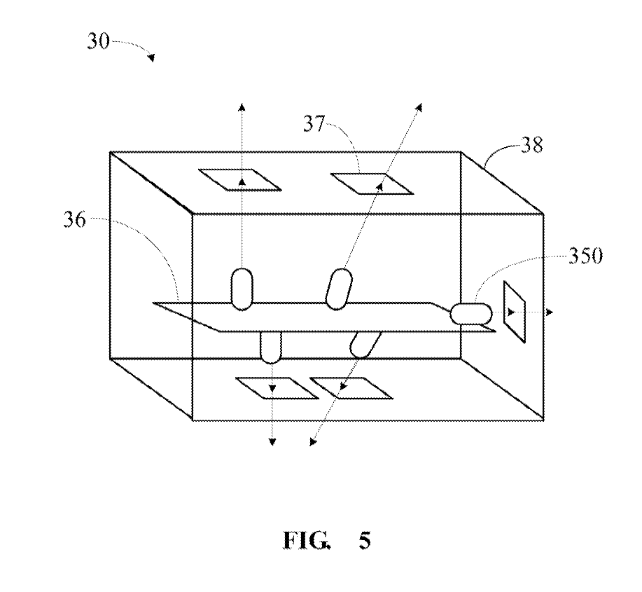

### DETAILED DESCRIPTION

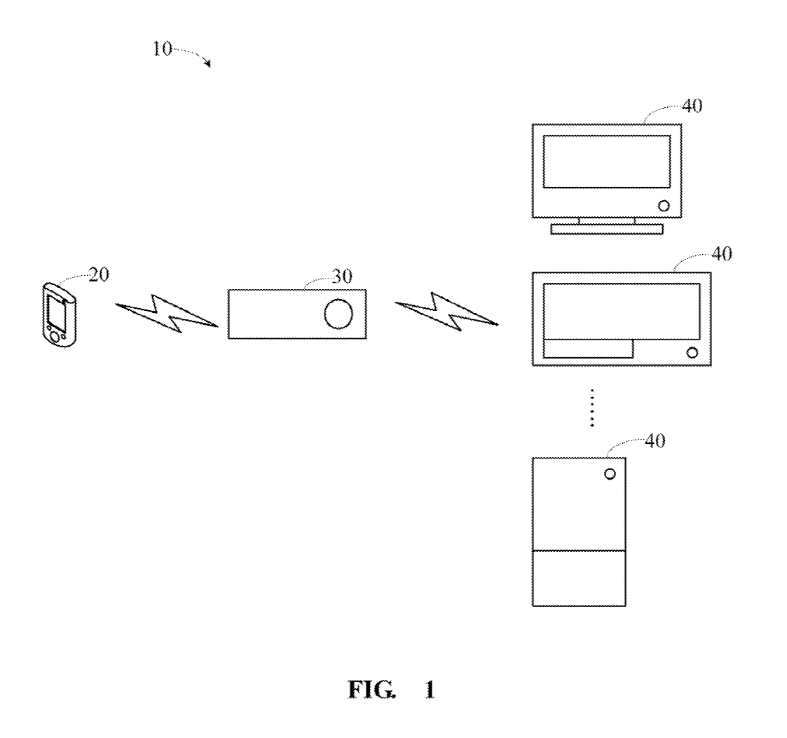

FIG. 1 is a schematic diagram showing a remote control system. The remote control system 10 includes a mobile terminal 20, a remote control apparatus 30, and at least one appliance 40. The mobile terminal 20, such as an e-book, a personal digital assistant (PDA), a mobile phone, or a tablet computer, communicates with the remote control apparatus 30 by wireless network, such as WiFi, Bluetooth, or ZigBee, for example.

The mobile terminal 20 displays information of the appliances 40 and function information of each appliance 40 which is pre-stored in the mobile terminal 20 for a user to select. The mobile terminal includes an input unit (not shown), configured for allowing a user to select the appliance 40 and select a function to be performed on the selected appliance 40. The mobile terminal 20 generates a wireless signal carrying an identification according to the selected appliance 40 and the selected function, and transmits the wireless signal to the remote control apparatus 30. The identification includes information and the selected function of the selected appliance 40.

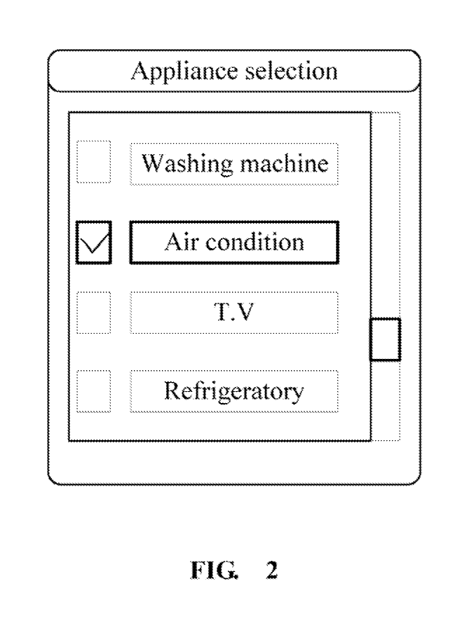

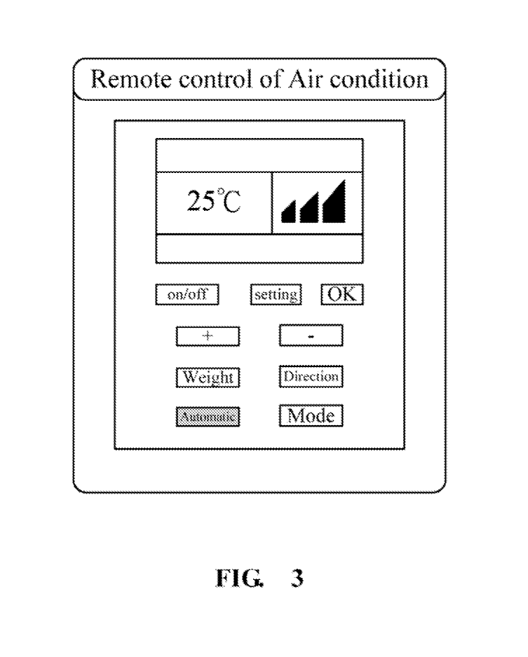

FIGS. 2 and 3, the input unit displays a first user interface displaying the appliance icons representing the respective appliances 40. For example, if the appliance icon “air condition” is selected, the input unit further displays a second user interface displaying function icons representing functions of the selected appliance icon. When one of the function icons is selected, the mobile terminal 20 generates a wireless signal with an identification for identifying the selected appliance 40 and the selected function to the remote control apparatus 30. In the embodiment, the mobile terminal 20 is a tablet computer with a touch screen, and produces a trigger signal in response to a user's touch. The mobile terminal 20 determines the selected appliance icon and function icon in response to the trigger signal.

In the embodiment, the mobile terminal 20 marks the previously selected function icon on the second user interface. For example, when the air condition is working in automatic state, the mobile terminal 20 displays the function icon “Automatic” marked on the second user interface in dark color.

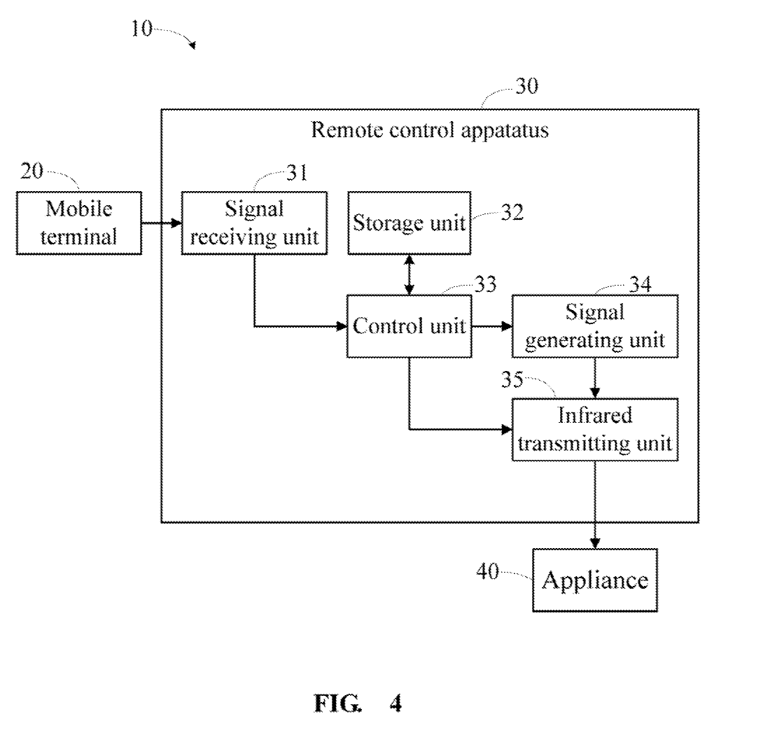

Referring to FIG. 4, the remote control apparatus 30 includes a signal receiving unit 31, a storage unit 32, a control unit 33, a signal generating unit 34, and an infrared transmitting unit 35. The storage unit 32 stores a relationship list containing mapping relationships among the appliances 40, the functions of each appliance 40, and the infrared remote control codes. The signal receiving unit 31 receives the wireless signal transmitted by the mobile terminal 20. The control unit 33 determines the selected appliance and the selected function based upon the wireless signal, and further determines the infrared remote control code associated with the selected function. The signal generating unit 34 generates an infrared remote control signal carrying the determined infrared remote control code. The infrared transmitting unit 35 transmits the infrared remote control signal generated by the signal generating unit 34. The selected appliance 40 receives the infrared remote control signal to execute the corresponding function. Thereby, the mobile terminal 20 remotely controls the appliance 40 via the remote control apparatus 30.

Referring to FIG, 5, a circuit board 36 is embedded in the remote control apparatus 30 including a mounted signal receiving unit 31, the storage unit 32, the control unit 33, the signal generating unit 34, and the infrared transmitting unit 35. In the embodiment, the infrared transmitting unit 35 includes a number of infrared transmitting modules 350. Each of the infrared transmitting modules 350 communicatively corresponding to an appliance 40 and configured for emitting infrared remote control signals to the corresponding appliance 40. In the embodiment, the remote control apparatus 30 includes a housing 38 having a plurality emitting windows 37, and the infrared transmitting module 350 received in the housing 38 aligned with the respective emitting windows 37. The infrared transmitting unit 35 controls an infrared transmitting module 350 which communicatively corresponds to the selected appliance 40 to transmit the infrared remote control signal passing the corresponding emitting window 37 to the selected appliance 40 execute the selected function.

The relationship list stored in the storage unit 32 further contains a mapping relationship between the number of infrared transmitting modules 350 and the appliances 40. In embodiment, the infrared transmitting modules 350 are coded. The relationship list further contains a relationship between the codes of the number of infrared transmitting modules 350 and the names of the appliances 40. When the selected appliance 40 and the selected function of the selected appliance 40 are determined, The infrared transmitting unit 35 enables the corresponding infrared transmitting module 350 of the selected appliance 40 to transmit the infrared remote control signal generated by the signal generating unit 34 to the selected appliance 40.

In an alternative embodiment, the remote control apparatus 30 includes a plurality of signal generating units 34 and a plurality of infrared transmitting modules 350. The relationship list further contains mapping relationships among the signal generating units 34, the infrared transmitting modules 350, and the appliances 40. When the selected appliance 40 is determined, the infrared transmitting unit 35 determines the signal generating unit 34 and the infrared transmitting module 350 corresponding to the selected appliance 40 according to the relationship list. In addition, controls the determined infrared transmitting module 350 to transmit the infrared remote control signal generated by the determined signal generating unit 34 to the selected appliance 40.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A remote control system for remotely controlling a plurality of remote controllable appliances, comprising:
a mobile terminal including an input unit configured to allow a user to select a remote controllable appliance and select a function to be performed on the selected appliance, the mobile terminal configured to generate a wireless signal carrying an identification according to the selected appliance and the selected function, wherein the identification includes information of the selected appliance and the selected function; and
a remote control apparatus configured for communicating with the mobile terminal by wireless network, the remote control apparatus comprising:
a signal receiving unit configured to receive the wireless signal transmitted by the mobile terminal;
a control unit configured to determine the selected appliance and the selected function based upon the wireless signal, and further determine an infrared remote control code associated with the selected function;
at least one signal generating unit configured to generate an infrared remote control signal carrying the determined infrared remote control code; and
an infrared transmitting unit comprising a plurality of infrared transmitting modules, each of the infrared transmitting modules communicatively corresponding to a remote controllable appliance and configured for emitting infrared remote control signals to the corresponding remote controllable appliance; wherein the infrared transmitting unit is configured to control a infrared transmitting module which communicatively corresponds to the selected appliance to transmit the infrared remote control signal to the selected appliance to execute the selected function.

2. The remote control system as recited in claim 1, wherein the input unit is configured to display a first user interface displaying the remote controllable appliances' icons representing the respective remote controllable appliances, and a second user interface displaying function icons representing functions of the selected appliance if one of the remote controllable appliances' icons displayed on the first user interface is selected.

3. The remote control system as recited in claim 2, wherein the mobile terminal is configured to mark the previously selected function icon on the second user interface.

4. The remote control system as recited in claim 1, wherein the remote control apparatus includes a housing having a plurality of emitting windows, and the infrared transmitting module received in the housing aligned with the respective emitting windows.

5. The remote control system as recited in claim 1, wherein the remote control apparatus further comprises a storage unit configured to store a relationship list containing mapping relationships among the identifications, the infrared remote control codes, and the infrared transmitting modules.

6. The remote control system as recited in claim 5, wherein the remote control apparatus comprises a plurality of signal generating units, the relationship list further contains mapping relationships among the signal generating units, the infrared transmitting modules, and the remote controllable appliances; when the selected remote controllable appliance is determined, the control unit is configured to determine the signal generating unit and the infrared transmitting module corresponding to the selected remote controllable appliance according to the relationship list, and control the determined infrared transmitting module to transmit the infrared remote control signal generated by the determined signal generating unit to the selected appliance.

7. A remote control apparatus for remotely controlling a plurality of remote controllable appliances, comprising:
a signal receiving unit configured to receive a wireless signal carrying an identification transmitted by a mobile terminal, wherein the identification includes information of selected remote controllable appliance and the selected function to be performed on the selected remote controllable appliance;
a control unit configured to determine the selected remote controllable appliance and the selected function according to the identification, and further determine an infrared remote control code associated with the selected function;
at least one signal generating unit configured to generate an infrared remote control signal carrying the determined infrared remote control code; and
an infrared transmitting unit comprising a plurality of infrared transmitting modules, each of the infrared transmitting modules communicatively corresponding to a remote controllable appliance and configured to for emitting infrared remote control signals to the corresponding remote controllable appliance; wherein infrared transmitting unit is configured to control a corresponding infrared transmitting module which communicatively corresponding to the selected appliance to transmit the infrared remote control signal to the selected appliance to execute the selected function.

8. The remote control apparatus as recited in claim 7, wherein the remote control apparatus includes a housing having a plurality of emitting windows, and the infrared transmitting module received in the housing aligned with the respective emitting windows.

9. The remote control apparatus as recited in claim 7, further comprising a storage unit configured to store a relationship list containing mapping relationships among the identifications, the infrared remote control codes, and the plurality of infrared transmitting modules.

10. The remote control apparatus as recited in claim 9, wherein the remote control apparatus comprises a plurality of signal generating units, the relationship list further contains mapping relationships among the signal generating units, the infrared transmitting modules, and the remote controllable appliances; when the selected remote controllable appliance is determined, the control unit is configured to determine the signal generating unit and the infrared transmitting module corresponding to the selected remote controllable appliance according to the relationship list, and control the determined infrared transmitting module to transmit the infrared remote control signal generated by the determined signal generating unit to the selected remote controllable appliance.
